(19) United States
(12) Patent Application Publication
(10) Pub. No.: US 2015/0113375 A1
(43) Pub. Date: Apr. 23, 2015

(54) Search Driven Navigation for User Interface to Application Program

(71) Applicant: PANTON INCORPORATED, Houston, TX (US)

(72) Inventor: Saishi Frank Li, Sugar Land, TX (US)

(21) Appl. No.: 14/061,645

(22) Filed: Oct. 23, 2013

(51) Int. Cl. G06F 3/0482; H04L 12/24; G06F 17/30; G06F 17/22

(52) U.S. Cl. CPC G06F 3/0482; G06F 17/2235; G06F 17/2247; H04L 41/22; G06F 17/30864
USPC 715/205; 715/825

(57) ABSTRACT

A computer program process and system for generating user interfaces incorporates a search-driven navigation method for invoking commands to an application program running on the computer. A user interface is generated for display by a user interface process running on a computer. The user interface receives from a user of the application program one or more keywords. The process uses those keywords to look up one or more commands or files available to the user to control the application program with names and/or descriptions that match or are otherwise associated with the one or more keywords. The user interface is updated to display the one or more commands and/or files. Upon selection by the user of one of the one or more commands the application responds to the command and updates the interface based on the selected command.

### BACKGROUND

Computer software applications running on many types of computing systems—for example, a personal computer, “smartphone,” and any types of devices with a memory storing program instructions and a processor for executing them—typically rely on graphic user interfaces (GUI) to allow for user interaction with the application. A GUI allows users to interact with an executing application through graphical elements, such as icons, text, and other visual indicators that are displayed to the user and that correspond to user commands. Selection of a graphical element by a mouse, for example, causes one or more processes to be performed by the computer under direction software programs by calling one or more functions or, in the case programs written in an object oriented language, methods. These functions are responsive to the user command represented by the graphical element. This is in contrast to a command line interface or shell, which requires that a user type in a command as a line of text, the shell takes the command and translates it to one or more functions that the application is called upon to perform.

A GUI can be, and often is, programmed as a process separate from the underlying logic for the application. To perform a user command, the GUI calls directly or indirectly functions or methods. Functions or methods are processes implemented by software instructions stored in memory and executed by a processor. These functions or methods can be implemented as part of the application program or, alternately or in combination with the application, by previously written executable software programs on which the application and its user interface rely. Examples of such programs include other application programs, such as database programs and web servers, as well as libraries of common routines, application programming interfaces and other frameworks, and the computing system's operating system.

Although there are many approaches in a GUI to presenting user commands, a traditional approach is to arrange the user commands in a structured menu system, often arranged in a hierarchical fashion, with a main menu, sub-menus, and sub-sub-menus. Some applications also use “tool bars,” “palettes,” or “ribbons” on which icons corresponding to functions are displayed and arranged. The arrangement of functions within a menu, or on a tool bar, palette or ribbon, are determined, at least initially, by the application developer, though some ability to customize a menu by a user is sometimes provided.

Rather than to run natively or locally on a computer an application can be designed to run on one computer and be accessed from another, remote computer using a “server client” model. Such applications are often referred to being “hosted” or “software as a service.” Although there are a number of thin client technologies that can be used for remotely hosted applications, a common type of implementation for an application that provides remote access through a user interface is a “web” application. Web applications typically make use of a standardized application service called the World Wide Web. Web applications typically rely on a client application running on the remote computer called a “web browser” to render and display a web page that functions as an interactive user interface to the application program.

In a client server model a hosted application runs on one or more computers called servers. (Further references to a “server” should be construed to mean one or more computers unless otherwise expressly indicated.) The term server may also refer to the program providing the services. The program requesting services from the server, as well as the computer on which it runs, is referred to as the client. The communication mechanism used by the server allows for the client program and the server program to be on different computers, though they can be on the same computer.

A user interface for a web application is typically dynamically generated by the application (with the help of, or through, other programs) and transmitted by a web server to a client application on a remote computer in the form of a document written in a markup language. Typically, the document contains references to other resources (e.g. files) called links. The most common example of such a client application that uses standard protocols (among others) to communicate and render documents or files is a “web browser.” Although they typically do, web browsers and web pages do not have to follow recommendations of the World Wide Web Consortium (W3C) for documents written using markup languages and containing references or links to other programs. References herein to the “web” should not be interpreted as referring only to W3C compliant protocols and standards.

The page displayed by the client application is based on the transmitted document or updates to that document that might be transmitted to the client application by the web server or other servers. This document, as well as the rendering or presentation of it, is sometimes referred to as a “web page.” The document is rendered by the web browser and, if necessary, one or more helper applications sometimes called plugins. Web pages are most often written using HTML (Hypertext Markup Language) or XHTML (Extensible HTML), with Cascading Style Sheets (CSS), but they do not have to be. An HTML document typically specifies how the information or text within the document is to be presented or rendered for display by the client, but it does not have to.

A document may include references to additional resources that are required to fully render the desired web page, including scripts or additional program files that are downloaded and interpreted or executed by the web browser or helper program sometimes called a “plug in.” Examples of such other files include those written to be executed, interpreted or rendered by Adobe Corporation's Flash® or Microsoft Corporation's Silverlight® runtime environments. Web browsers may be inherently capable of executing or interpreting small programs or scripts embedded in or referenced by the document, though they may need the help of a plugin program such as Oracle's Java® runtime environment that interprets them.

The communication between a W3C compliant web server and a web browser or other client application typically relies, in part, on the Hypertext Transfer Protocol (HTTP). HTTP follows a simple request-response process. For example, the client requests that the web server return a resource using a Uniform Resource Indicator (URI). The web server returns the requested resource. That resource can be an HTML document or many other type of file. The client may request that the server accept and act on data by sending certain types of requests with a URI and the data.

User interfaces for web applications tend to mimic those for native applications. Graphical representations of available user commands are displayed using menus, pallets, drop-down lists, and many other ways. Selection of the graphical representation triggers, for example, a request to a web server that causes the web application to perform one or more functions. The web server responds to such requests with data generated by the web application that updates the web page functioning as the user interface. The updated data may be new HTML or XHTML document or may include data that can be used by scripts or other files referenced by a previously sent document that are being run within the web browser.

### SUMMARY

The invention pertains generally to computer program processes and systems generating user interfaces that incorporate search-driven navigation method for invoking commands to an application program running on the computer. The search driven, command navigation interface may completely replace, or partially replace and/or augment, conventional elements for selecting functions or commands available to a user of an application.

In one example a user interface is generated for display by a user interface process running on a computer. The user interface process is part of, or interacts with, an application program process running on a computer. The user interface receives from a user of the application program one or more keywords. The process uses those keywords to look up in, for example, a data store, one or more commands available to the user to control the application program with names and/or descriptions that match or are otherwise associated with the one or more keywords. The process causes the user interface to be updated to display the one or more commands. Upon selection by the user of one of the one or more commands the process causes the application to update the interface based on the selected command.

The process is particularly useful for web applications. In a representative embodiment for a web application program, a document for generating a web page that functions as the user interface is transmitted to a client program, such as a web browser. The document includes search box or field or other graphical element into which a user may insert one or more keywords. When the client program transmits back a message with one or more keywords, the process searches in a data store and determines one or more references or links that the client application can use to invoke the command, resulting in an update to the user interface being generated by the application, which update is transmitted and then presented or displayed by the client program. Such an update to the user interface may include, for example, a link to a file that is downloaded in response to selecting a command.

Thus, rather than navigating a menu of commands or functions for the application, a user uses a command to access a particular function or process of an application program, the user types a command name, or perhaps other keywords associated with the command, in a search box. The application then provides the interface for the desired command. For example, if a client needs to run a report, they would log into the web page generated by a web server, and type the word “report” into the search box. All commands to which the application is programmed to respond that relate to “report” would be listed with links that, when selected, causes the application program to perform one or more functions or processes and to update the user interface accordingly.

In another embodiment, the user interface process remembers returned commands selected by the user and generates a listing of recent commands selected by the user when generating a user interface for that user. The listing acts as a personal menu. The state of this list is preferably maintained by the user interface process or other process that is part of, or associated with, the application process so that, next time the user visits or logs into the application, the list is displayed, allowing immediate access for previously accessed user commands for the application.

One advantage of these preferred embodiments of this user interface processes is that the processes allow for simplification of the way a person interacts with a web-based software application, thus allowing for less training for learning or understanding an application user command system.

In another embodiment, users of the application accessing it remotely may publish anything related to a document(s), such as analyses, reports, photos and findings prepared using the application, to other users of the application process by uploading the files to the application process running on the remote server. When a user searches for a user command with one or more keywords, a document relevant to the search query is returned as part of the listing or grouping of commands responsive to the keyword query. Examples of keywords that could be used in determining a results list include strings contain in the document's name and/or content.

### BRIEF DESCRIPTION OF THE DRAWINGS

FIG. 1 is a schematic representation of computing device.

FIG. 2 is a schematic representation of computers and processes running on the computers for implementing the processes of FIGS. 3A and 3B.

FIG. 3A is a flow diagram illustrating steps of a representative example of a computer implemented, search driven process for navigating the commands available to a user of an application program.

FIG. 3B is a flow diagram illustrating steps of a representative example of a computer implemented process for uploading a file to be available as part of the search driven process for navigating commands for an application program represented by the flow chart of FIG. 3A.

FIG. 4 shows a representative example of a web page functioning as login user interface to an application program.

FIG. 5 illustrates a representative example of the user interface to the application program that has been updated after login of a user.

FIG. 6 illustrates a representative example of the user interface to the application program that has been updated to include a listing of commands responsive to a keyword entered into a search box.

FIG. 7 illustrates a representative example of the user interface to the application program that has been updated after a command has been selected from the list of commands.

FIG. 8 illustrates a representative example of an updated user interface to the application program to include a file upload dialog box with which a user may specify a file for uploading to the application for inclusion as part of the application commands that can be searched.

FIG. 9 illustrates a representative example of an updated user interface to the application program to show results of a keyword search for commands for the application program to show a previously uploaded file.

### DETAILED DESCRIPTION OF EXEMPLARY EMBODIMENTS

In the following description, like numbers refer to like elements.

The schematic illustration of FIG. 1 represents one example of a computing machine 100 for implementing all or part of the processes described below. References to “computer” below are intended to be a reference to a computing machine. The computing machine is programmable by means of instructions stored within its memory. The computing machine comprises one or more processors for reading and executing instructions. Steps for carrying out the processes are encoded in one or more sets of instructions, or programs. When instructions comprising program code for performing each one of the process steps are read by one or more computing machines and executed by the one or processors on those machines, they perform those parts of the processes described below indicated as being computer implemented.

Examples of computing machines include, but are not limited to, personal computers (PC), tablet computers, set-top boxes, smartphones, personal digital assistants (PDA), cellular telephones, web appliances, network routers, switches and bridges. Further, while only a single machine is illustrated, the term computer machine is intended to include, unless the context explicitly indicates otherwise, multiple or plural computing machines that individually or jointly (in, for example, a distributed fashion) execute a set of instructions comprising at least part of a program, or multiple programs, to perform any one or more of the computer implemented processes described herein.

Exemplary computing machine 100 includes a processor 102. The processor is representative of implementations having one or more central processing units (CPUs), a graphics processing unit (GPU), other types of processors, and combinations of CPUs, GPUs, and other types of processors. The processor communicates with a main or working memory 104 and a storage memory 106 over one or more buses represented by bus 108. The main memory is intended to be generally representative of short-term memory used by the processor for storing instructions and other data being processed, such as random access memory, including cache memory. Storage memory is representative of longer-term memory for storing program instructions and data structures, such as hard disks and solid-state disks. Bus 108 is intended to be representative of all types of bus architectures and other circuits for enabling communication between the processor 102 and other components of the computing machine.

The computing machine 100 communicates graphically with a user through visual display 110. Examples of visual displays include monitors such as liquid crystal displays, projectors, and other devices for creating visually perceptible images. The computer system 100 also includes one or more devices for enabling a user to enter information, control, and interact with the computing machine and a graphical user interface presented on the visual display. These are collectively designated 112 and may include, for example, depending on the computing machine, a keyboard, a mouse or track pad, a touchscreen, a microphone, and similar devices for providing interaction. A removable media reader 114, such as an optical disk drive that reads optical media or a memory card reader, enables the computing machine to read data from and/or write data to removable data storage media. The computing machine may also include other input devices, generally designated 116, such as cameras, a Global Positioning System (GPS) receiver, and environmental sensors, such as temperature, light, and acoustic sensors, accelerometers, and gyroscopes. The exemplary computing machine 100 further comprises a network interface 118 that enables the computing machine to communicate with one or more other computers.

Program instructions for executing the processes running on a computing machine, such as those described below, and data structures written or read by such processes, are stored on machine or computer readable media. Examples of such computer readable media include, but are not limited to, removable media being read by reader 114, main memory 104, and storage memory 106. While the machine-readable medium in the example embodiment can be a single medium, the terms machine readable medium and computer readable medium are generally intended to also include, unless the context clearly indicates otherwise, multiple media, and can be centralized or distributed among several computing machines. For example, multiple computing machines may implement a process, each performing only a part of the process, or a separate instance of the process. Program instructions, or portions of them, are distributed and stored on media being read and executed by processors on the different computing machines. Similarly, one or more instances of a data structure or group of data structures, such as a database, can also be distributed and stored on multiple media on multiple computing machines for use by the processes.

The term “non-transitory machine-readable medium” means any tangible medium or media, but not transitory signals, that is capable of storing, encoding, or carrying instructions for execution by the computing machine and that cause the computing machine to perform any one or more of the processes described below, or that is capable of storing, encoding, or carrying data structures used by or associated with such instructions. Examples of non-transitory machine-readable media include, but are not limited to, nonvolatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

Unless otherwise stated a “process” executing on a computer is not limited to a single instance of an execution thread of a microprocessor, but is intended to refer generally to any type of procedure, operation, action, activity, task, or method carried out by one or more computers under the direction of one or more programs stored in memory and executing on the computers.

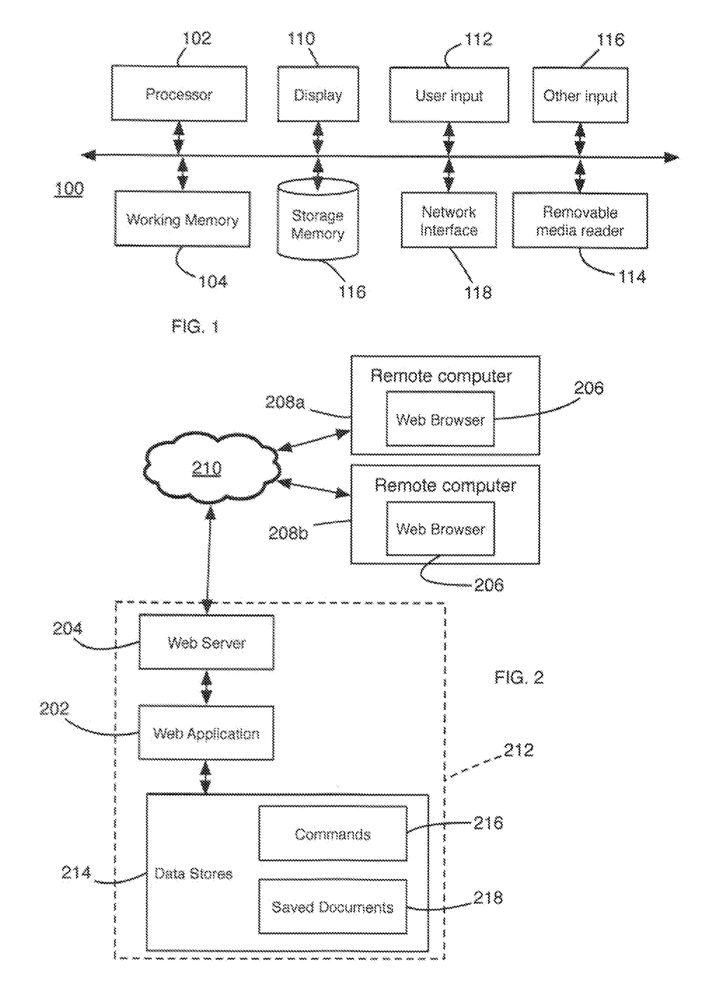

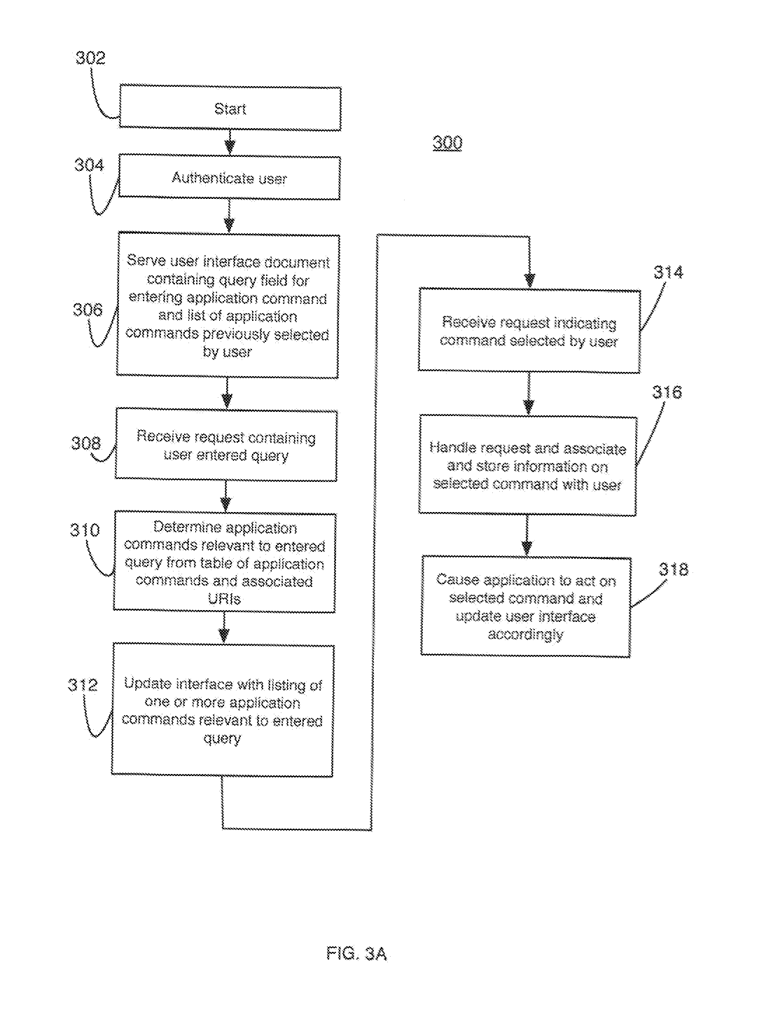

FIGS. 2 to 9 illustrate a computer implemented system, processes, and web pages that function as a graphical user interface for an application program. The application program generates (by itself with the help of other programs) documents written using a mark up language that, when are rendered and displayed as web pages by a client application running on a computer (either the same computer running the application or a remote computer), function as a graphical user interface to the application program.

FIG. 2 is a representative example of one possible implementation of a system for a web-based application 202. The application handles at least the basic logic for an application process, such as a process that generates reports. An example of such a web based application is described in U.S. patent application Ser. No. 13/722,482, which is incorporated herein by reference. Depending on the implementation, the application may make use of additional programs, such as libraries or application frameworks, which are prewritten program code for handling basic functions that can be used by application programs. For example, these libraries or frameworks can be called up to help with generating user interfaces, in particular documents that will be served to client applications for rendering as a user interface to the application. These additional programs, or code for interacting with these additional programs, may be made part of the executable file comprising the application program. However, these additional programs may also be implemented as separately executed files that are linked or communicate with the application program through other standard mechanisms.

The application program 202 communicates also with a web server 204. The web server handles communications with client applications that are rendering or displaying web pages served by the web server. However, the application and web server could be implemented, in alternative embodiments, as a single program. Furthermore, though the web server 204 and application 202 are indicated as running on the same computer 212, the web sever and application can be stored in memory on different server computers, and run on different processors. Multiple instances of the web server and the application may exist on the same computer or on multiple computers.

In this example, the client application comprises a web browser 206. However, client applications may include any type of application that can communicate with the web server and render, execute or interpret documents and other files served to it. The illustrated examples include a plurality of remotely located, client computers 208a and 208b, each running an instance of a web browser 206. Each instance of web browser 206 communicates over network 210 with the web server 204.

The application 202, and other programs with which it communicates or interacts, can make use of one or more data containers, which are generally represented by data stores 214. Data stores 214 are stored in memory of computer 212. However, they do not imply the nature or type structure in which the data is arranged, or the number of data structures. Furthermore, the data stores can be stored in memory on a different computer, or distributed over multiple computers.

The application 202 generates or causes to be generated a document that will be transmitted to a client application, and then rendered or displayed by the remote client application. The user interface for the application is therefore comprised of a document that describes a page to be rendered by a client application, such as a web browser 206. HTML encoded documents is one example of such document. Data is presented to the user as information that is generated dynamically in a standard format, (e.g. in HTML using cascading style sheets (CSS) or XHTML) by the web application through a web server. The document may reference other resources that are downloaded by the web browser or other client application when rendering the page or upon a certain action (e.g. entry of text, selection of a button or drop down menu, or selection of a link). These resources may include scripts, multimedia files, or other programs that are interpreted or executed by the web browser in connection with rendering the page and/or the user interacting with it. A user may interact with the user interface by, among other things, selecting a link on the rendered page. The link is comprised of text, icons and/or other graphical elements, which are displayed, and an associated reference to another resource in the form of, for example, uniform resource indicator (URI), which is not displayed.

A “web page” or “web document” as used herein, refers to any document or file that uses a markup language to describe a presentation of information of data (either in the document or obtained elsewhere) and includes links to other documents or resources. Although they typically do, web pages do not have to follow recommendations of the World Wide Web Consortium (W3C) for documents written using markup languages. Examples include documents written using HTML, CSS, and XHTML.

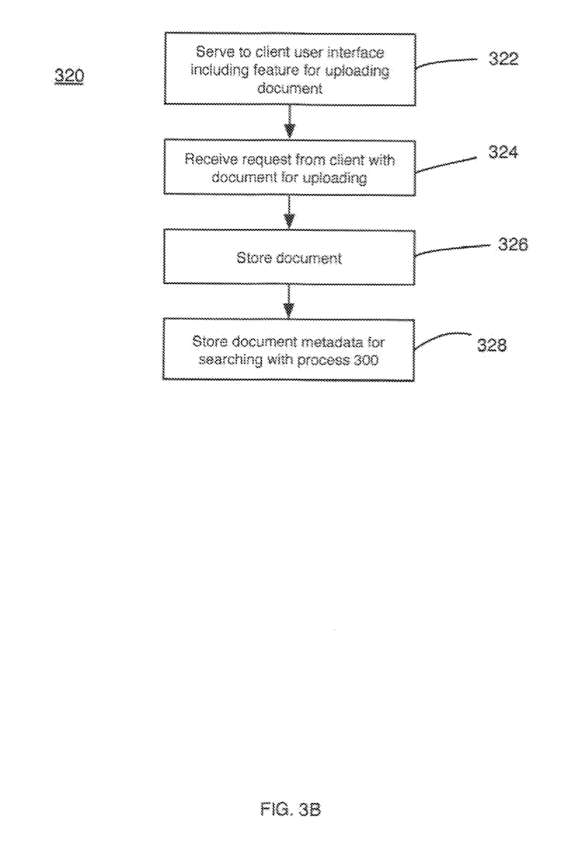

FIGS. 3A and 3B illustrate representative examples of interface processes 300 and 320 running on one or more computing machines for enabling a user to search for and issue predefined commands to an application program, such as application 202 of FIG. 2. These commands, exposed to the user through an interface, will be referred to as “application commands” or sometimes just “commands.”

For the example of FIG. 2 processes 300 and 320 may be implemented as part of application program 202 or as part of separate software that the application program makes use of, such as an operating system, web server, library, application framework.

Referring now to FIGS. 2 to 9, after starting at block 302 the process 304, optionally, authenticates the user. To authenticate an interface is generated by the application, either directly or through another program, such as a web server. In the example of FIG. 2, a document describing the interface is generated by or for the application 202 and served by web server 204 to a client application on a client computer.

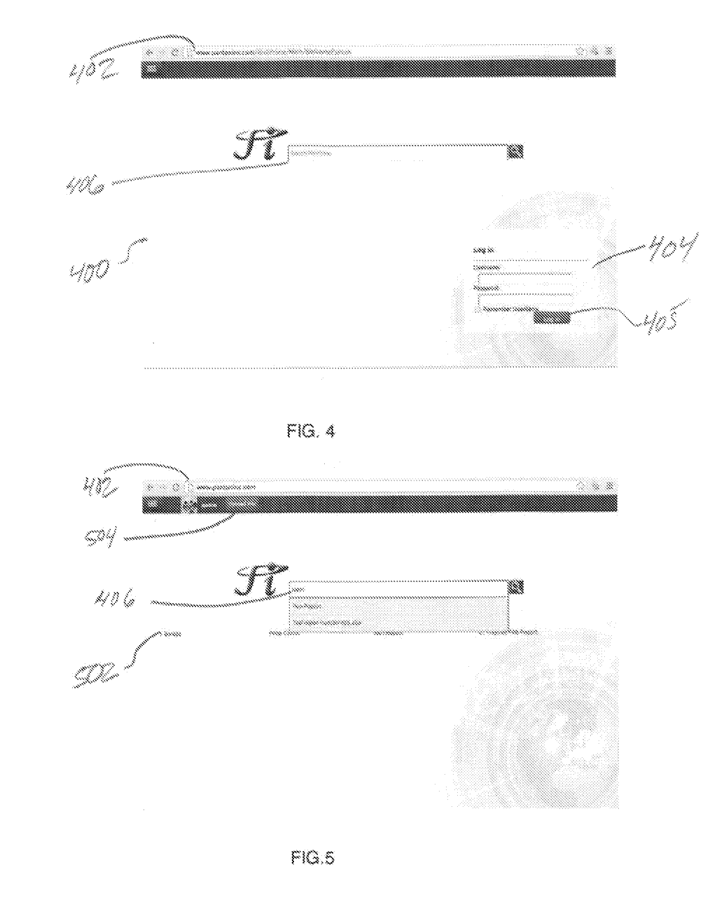

FIG. 4 illustrates an example of a web page 400, inside of a window of a web browser, functioning as a user interface to application program 202. Application 202 helps to generate a document that is sent and rendered by a web browser. The location of the document is in address field 402 of the web browser. The web page 400 also includes text boxes 404 into which a user may log into the application by entering a user name and password for transmission back to the application 202 through the web server 204 when the “Login” button 405 is selected. The web page also includes a text box 406 (a “search box”) created, for example, an input field in the HTML document, into which one or more keywords may be typed to search one or more of the application's predefined commands.

After authentication the process returns, at step 306, serves to the web browser 206 a response that updates the user interface.

In the illustrated processes 300 and 320, updating the user interface may be accomplished in one or more different ways, depending on the specific implementation chosen. For example, it may comprise generating a message that includes a new markup document, which is then transmitted to the client application. It may also comprise generating and sending a response message with data for updating portions of a document previously served. Alternatively, the transaction between the client application and the server application that updates the user interface can be handled through a script, multimedia file, or other program that exchanges data that updates the view.

FIG. 5 illustrates rendered web page 500, which is an example of the updated interface to the application after user authentication. It includes text box 406 for entering keywords to search for a command and a listing 502 of commands previously selected by the user. Once a user enters and submits one or more keywords into search box 406, the web browser transmits the keywords to the web server 204.

The process of FIG. 3A, at step 308, receives from the web browser the user's query, which includes one or more keywords. Any client or user initiated transaction or transmission from the client application can be, for example, triggered by selection by the user of a link that causes the client application to transmit a standard HTTP request message (for example, a put or post message), or execute a script that transmits a data object using the same or other mechanisms or protocols.

At step 310 the process looks up or determines (or causes a search process to be performed) in data stores 214 information on or more commands and, optionally, saved documents that match or are otherwise relevant or responsive to the keyword(s) in the query. In this example, data 216 represents information on commands. The data stores are stored in computer memory for use by the process 300. The data in data stores 214 can be any form of structured data, including one or more lists, arrays, tables, databases, or other structures that can be searched using strings. The terms “data store” or “database” do not imply any particular structure in this context. Command data 216 includes information for use by the application program 202 (including other programs with which it may communicate) for generating links that can be used by a client application to request that the application perform any one of a plurality of commands available to the user, and return the client application information for updating the user interface. This information may be in the form of a URI, a reference or pointer to a URI, or information from which a URI can be generated. The data store associates this information to keywords that can be searched to find and execute a command to which the application responds. Examples of keywords that can be searched for include names of commands, alternative names for the commands (e.g. synonyms), and descriptions for the commands. Depending on the URI structure, the keywords or command names may be made part of, or incorporated into, the URI, in which case the URIs can be directly searched. The information that is stored in memory as part of data stores 214 may also include document metadata 218 for one or more previously stored documents, such as reports, that have been, for example, uploaded by the user for use in connection with the application. Although these data containers are indicated as being stored on server 212, the data containers could, instead or in addition, be stored on a client computer 206. A script referenced as part of the document last served to the client application may perform step 308 and step 310.

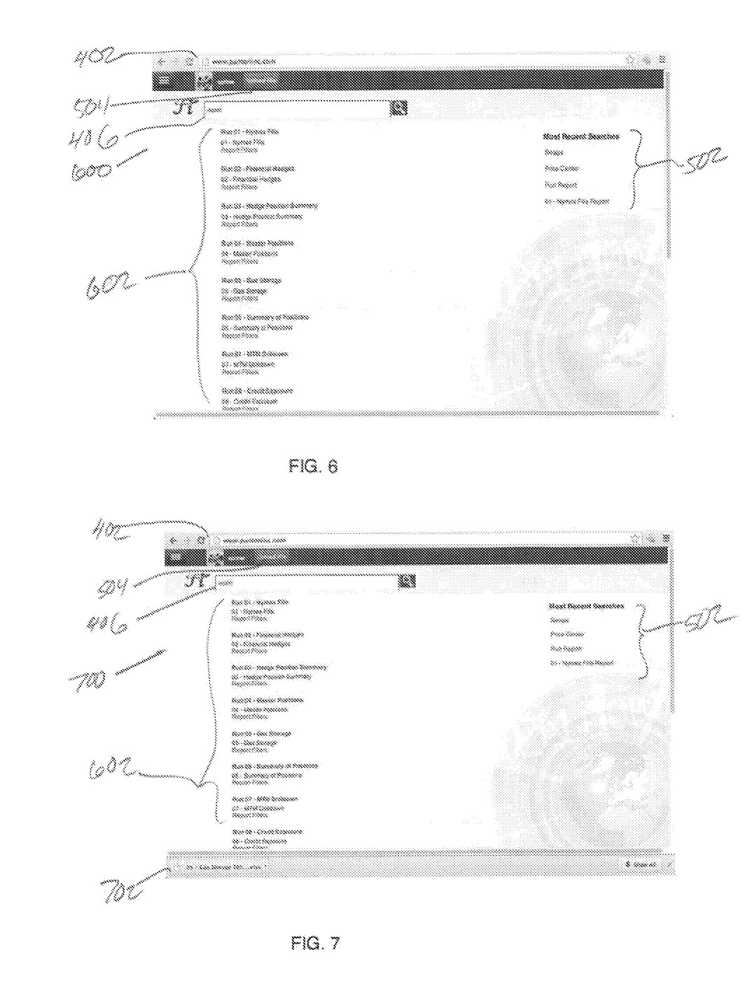

As represented by step 312 the process 300 of FIG. 3A determines what commands and stored documents are responsive and updates the user interface so that the client application renders a web page like web page 600 shown in FIG. 6.

Referring now to FIG. 6, web page 600 includes not only the search box 406 but also includes a listing of a plurality of commands 602 determined through the process to be responsive to the keywords entered and searched for at step 310 of process 300 of FIG. 3. These results can be presented any number of ways, such in a list as shown in the figure, or in some other type of graphical representation, such as icons arrayed in a tiled or other fashion. For convenience, the presentation of these commands will be referred to as “list” or “listing,” but such terms are intended to refer to any manner in which the these commands are displayed and not only to the listing shown in FIG. 6 and FIGS. 7-9. The illustrated example shows that the keyword “report” was entered in the search box 406, and that the commands returned include commands (“Run”) and the name of each of previously programmed reports that can be run. Each of the listed commands 602 is, in this example, in the form a link that includes the name of the command that is displayed as text and a hidden reference. The hidden reference can be, for example, to another resource that is identified by a URI or URL. The linked resource identifies to the application program 202 (FIG. 2) what actions the application program needs to take, including how to update the user interface, in response to that command when the user selects it. A link may contain, for example, the name of server and a resource (a file) on that server. The resource can be, for example, a script or program that, when run, interacts with the application program 202. The link may include a query string that the program identified in the link uses as a parameter or input. The query string may identify to the program the particular command chosen to the application program 202. In the alternative, the link could reference a local script or program on the client computer that is run and communicates, for example, with web server 204 and application program 202.

Now referring to FIGS. 2 and 3A, each command has associated with it a link that, when selected, causes the client application (e.g. the web browser) rendering the page to send a request message to the web server 204, which is referenced in the link. The request is received at step 314. As represented by step 316, the received request, which was initiated by a user selecting the link corresponding to the desired command from the plurality of commands 602, is handled by, for example, web server 204. The desired command is also remembered and associated with the user, such as by storing it in data store 214, so that it can be included in a list 502, shown in FIGS. 5-9, of previously searched for commands when the user interface is updated. At step 318, the application program 202 performs one or more processes to handle the command indicated in the request and generates, in response to the message, an update to the user interface that is transmitted to the client application in the form of a response to the request.

FIG. 7 shows an example of an updated user interface in the form of web page 700. This web page was generated in step 318 in response to selection of a listed command returned from a search. In this particular example, a previously programmed report was selected from list 602 was “Run,” causing the report to be downloaded as a spreadsheet file and stored locally, as represented by icon 702. The report could, depending on its format, could have instead been displayed within the web page or the web browser.

To summarize, in the examples illustrated in FIGS. 3A, 5, 6 and 7, when the user types a word into the search box 406, for example the word “report,” that keyword is transmitted back to the application 202. The application looks up and present links to all commands whose name and/or description matches the key word. The user interface is updated with the links 602 displayed below the search box. When the user selects any link, an updated interface corresponding to the link is generated and the selection is recorded and is associated with the user (or the user's name or other identifier). Therefore the selection becomes part of a personal or default menu in the form of list 502. The next time when this user logs in, the user does not need search the same function again for the same commands already searched. They are listed as the “default links” in a personalized menu.

For example, one command that application 202 responds might be an interface for determining “sales volume.” Then the description of this command, or the interface, would contain the key words “sales” and “volume.” When user logs into the application and searches for “sales” or “volume,” the link leading to this “sales volume” interface will show up, along with other links whose keywords contain “sales” or “volume.” The users do not need know anything about the application or use a complex menu of commands.

Each of the user interfaces shown in FIGS. 5-9 includes an icon 504 that, when selected, enables uploading of a file, such as standard report, for use by other users of application 202. FIG. 3B illustrates a process 320 for doing so.

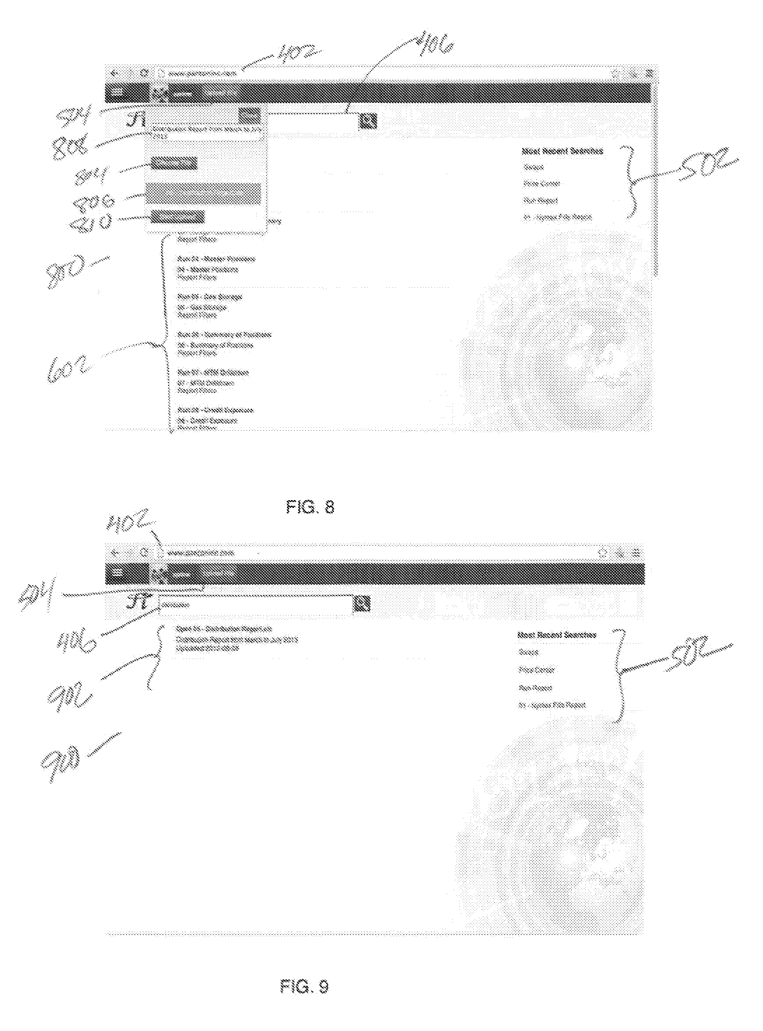

Referring to FIGS. 3B and 8, when icon 504 is selected at step 322, a file upload dialog box 802 drops down on updated user interface 800. This upload dialog and functionality can be implemented by small program or script referenced by the document from which the web page is being rendered, downloaded and run. The user selects “Chose File” button 804 to open an operating system dialog box (not shown) for navigating to and select a file for upload. The name of the chosen file is shown in box 806. A description of the file is entered by the user into field 808, and button 810 is selected to start a process executing on the client application to upload to the web server 204 the chosen file. Once received, as indicated by step 324, the document is stored at step 326, and data container 218 is updated at step 328 with a reference to the uploaded file and the description of the document entered by the user.

FIG. 9 illustrates an example of an updated user interface in the form of web page 900, in which the document uploaded in FIG. 8 has been found by entering a keyword in search box 406. The document is listed with the command “Open” in a listing 902 of commands matching the keyword entry. In this example, the document name and description each contained “distribution,” and the keyword that was entered by the user was “distribution.”

The foregoing description is of exemplary and preferred embodiments. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated or described structures or embodiments.

What is claimed is:

1. A computer implemented method for enabling user interaction with an application program, the application program being responsive to a predefined plurality application commands, the method comprising:
generating with a program running on a computer data for creating a graphical user interface to the application program, the graphic user interface including an input area for receiving from the user one or more keywords terms;
receiving one or more query terms entered into the input area by a user;
searching a data store on the computer containing information describing the plurality of predefined application commands and determining one or more found application commands relevant to the one or more keyword terms;
updating the graphical user interface to display a listing of one or more found application commands;
receiving an indication of a selection of the one or more found application commands from the listing; and
causing the application program to respond the selected application command.

2. The method of claim 1, wherein generating a graphical user interface comprises generating a markup document for rendering by a client application, the document containing one or more links.

3. The method of claim 2, wherein the one or more found application commands is each associated with a link that, when selected, sends a request message indicating the command to a predetermined server, the server causing the application program to respond to the message by executing one or more process for executing the command associated with the link and generating an updates to the user interface.

4. The method of claim 1, further comprising:
storing and associating in memory with a user the selected application command; and
listing in the user interface previously selected application commands for the user.

5. The method of claim 1, further comprising
receiving an uploaded document; and
storing in the data store data for identifying the document.

6. A computer system running an application program that is responsive to a plurality of defined application commands selectable by a user, the computer system comprising a memory storing the application program and a processor executing the application program, the computer system interacting with a remote computer executing on a processor a client application stored in memory, the computer system comprising,
means for generating a user interface for display by the remote computer;
means for searching in predetermined data store on the computer system containing information describing the plurality of predefined application commands for one or more application commands corresponding to search terms received from the remote computer in response to a user inputting the search terms into the user interface;
means for updating the user interface to include the one or more commands; and
means for causing the application to respond to one of the one or more commands selected in the updated user interface by the user.

7. The computer system of claim 6, wherein the means for generating a graphical user interface generates a markup document for rendering by a client application for display on the remote computer, the document containing one or more links.

8. The computer system of claim 7, wherein the one or more application commands is each comprised of a link that, when selected by a user, sends a request message indicating the associated command to the means for causing the application to respond, update and refresh.

9. The computer system of claim 6, further comprising means listing in the user interface previously selected application commands for the user.

10. The computer system of claim 6, wherein the data store further comprises information on a document uploaded by a user, and wherein the one or more commands includes a command for acting on the document in response to a search term matching the document.

11. A server computer system running an application program that is responsive to a plurality of defined application commands selectable by a user, the computer system comprising a memory storing the application program and a processor executing the application program, the server computer system communicating with a client computer, the client computer comprising a processor, memory and a display, the client computer executing on its processor a client application that is stored in the client computer's memory; wherein the application program, executing on the server computer system;
generates a document for creating a graphical user interface to the application program, the document describing to the client application rendering of the graphical user interface having at least one input area for receiving from the user one or more keywords term;
searches, in response to the server computer system receiving the one or more query terms from the client computer, a data store containing information describing the plurality of predefined application commands and determining one or more found application commands relevant to the one or more keyword terms;
generates an update to the graphical user interface to display a listing of one or more application commands found from the search of the data store, the server computer system communicating the update to the client computer; and
responds to selection of one of the one or more commands within the user interface on the client computer when the selection is received by the server computer system.

12. The server computer system of claim 11, wherein the application program generates a markup document for rendering by the client application, the document containing one or more links.

13. The server computer system of claim 11, wherein the one or more found application commands are each associated with a link that, when selected, sends a request message indicating the command to the server computing system, the server computing system causing the application program to respond to the message by executing one or more process to carry out the command associated with the link and generating a future update to the user interface.

14. The server computer system of claim 11, wherein the application stores and associates in memory with a user each application command selected by the user, and generates, as part of the user interface, a listing of previously selected application commands for the user.

15. The server computer system of claim 11, wherein the server computing system receives from the client computer an uploaded file and causes the application program to store in the data store information for identifying the uploaded file.
